(19) United States
(12) Patent Application Publication
(10) Pub. No.: US 2023/0102889 A1
(43) Pub. Date: Mar. 30, 2023

(54) NON-FUNGIBLE TOKEN-BASED PLATFORM FOR TRACING SOFTWARE AND REVISIONS

(71) Applicant: BANK OF AMERICA CORPORATION, Charlotte, NC (US)

(72) Inventors: Kelly Renee-Drop Keiter, Waxhaw, NC (US); Michael Robert Young, Davidson, NC (US)

(73) Assignee: BANK OF AMERICA CORPORATION, Charlotte, NC (US)

(21) Appl. No.: 17/479,491

(22) Filed: Sep. 20, 2021

(51) Int. Cl. G06F 21/10; H04L 9/32; G06F 21/55

(52) U.S. Cl. CPC G06F 21/105; G06F 21/554; H04L 9/3255; G06F 2221/033; G06F 2221/0788

(57) ABSTRACT

A non-fungible token (NFT)-based platform is provided for validating the authenticity of software and providing software traceability on a device and/or user-level. Software is configured by the developer with logic that detects installation and, in some embodiments, change (i.e., upgrades, patches or the like) and, in response generates a non-fungible token (NFT) that is subsequently verified via a distributed trust computing network. The NFT may be linked to one or more of the device, the user(s), IP address(es), licensee, such that a distributed ledger storing the linked NFTs can be accessed to readily determine which devices the software is installed on and the users of the software.

### FIELD OF THE INVENTION

The present invention is generally related to verifying the authenticity of software and providing traceability of software at the device and user levels and, more specifically, using logic in software to generate non-fungible tokens (NFT) in response to installation and/or changes to software, linking the tokens to (i) the device on which the software is installed, (ii) the user, (iii) the IP address and/or (iv) the licensee and storing the NFT on a distributed ledger of a decentralized trust computing network as a means of verifying the authenticity of the software and providing traceability back to the device, user, IP address and/or licensee-level.

### BACKGROUND

Software is typically configured to transmit telemetry as a means of verifying proper licensee usage and conducting automated updates. However, software is not typically configured to allow for determining a chain of custody (i.e., which devices the software has been installed on and/or the users of the software). Having access to such information would be highly beneficial in the event that the software is compromised or otherwise poses a security threat.

Therefore, a need exists to develop systems, computer-implemented methods, and the like for verifying the authenticity of software being installed and/or updated and providing for traceability in terms of devices that the software is installed on and specific users of the software. As such, in the event that the software is compromised or poses a security threat, a need exists to provide the developer and/or licensee the ability to readily determine on what devices the software is installed and the users of the software.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing the ability to validate the authenticity of software and trace/track software on a device and/or user-level. In this regard, software is configured by the developer with logic/code that detects installation and, in some embodiments, changes to the software (i.e., upgrade, patches or the like) and, in response, generates a non-fungible token (NFT) that is subsequently verified via a distributed trust computing network. Such verification at the distributed trust computing network authenticates the software and/or software updates.

In specific embodiments, the NFT is linked to one or more of the device, the user(s), IP address(es), licensee, such that a distributed ledger storing the linked NFTs can be accessed to readily determine which devices the software is installed on and the users of the software. The ability to readily determine which specific devices software is installed on and/or the specific users of the software becomes paramount in the event that the software is compromised or otherwise poses a security threat. As such, in specific embodiments of the invention, a threat monitoring system is used in conjunction with the NFT-based platform, such that in response to identifying a security threat, the distributed ledger is accessed to identify devices and/or users of the software and appropriate actions are taken at the device-level and/or the users may be notified.

In further embodiments of the invention, when unauthorized changes occur to the software, the distributed trust computing network will fail to validate the updated NFT that was generated as a result of the change. In this instance, the invention provides for taking appropriate actions, such as preventing the use of the software on the device, isolating the device from network communication and the like.

A system for software authenticity and traceability defines first embodiments of the invention. The system includes a distributed trust computing network that includes a plurality of decentralized nodes. Each decentralized node has a first memory and at least one first processor in communication with the memory. The first memory of the decentralized nodes is configured to store a distributed ledger comprising a plurality of blocks of data. The system additionally includes a software program with logic. The logic is configured to detect an installation of the software program on a device, and, in response to the detection of the installation of the software program on the device, generate a non-fungible token (NFT) and communicate the NFT to the distributed trust computing network. In response to the distributed trust computing network receiving the NFT, the decentralized nodes of the distributed trust computing network are configured to (i) reach a consensus on the NFT to verify an authenticity of the software program, and (ii) create a first block of data within the distributed ledger that stores the verified NFT.

In specific embodiments of the system, the logic is further configured to link the NFT to at least one chosen from group consisting of the device, one or more users of the device, an Internet Protocol (IP) address assigned to the device and a licensee of the software program. In such embodiments of the system, the first block of data within the distributed ledger stores data that identifies at least one chosen from the group consisting of the device, the one or more users, the IP address, and the licensee. In such embodiments of the system, the logic is further configured to link the NFT to at least one chosen from group consisting of the device, a user of the device, an Internet Protocol (IP) address assigned to the device and a licensee of the software program by accessing an Operating System (OS) kernel to identify at least one chosen from the group comprising one or more unique signatures of the device, one or more unique signatures of the one or more users, the IP address or the licensee.

In other specific embodiments the system includes a computing platform including a memory and at least one processing device in communication with the memory. The memory stores a threat monitoring application that is executable by the at least one processing device and is configured to monitor the software program for an occurrence of a security threat, and, in response to detecting a security threat, access the distributed ledger to determine devices on which the software program is installed and/or users of the software program. In response to determining the devices on which the software program is installed and/or users of the software program, perform an action at the devices to prevent the security threat from affecting the devices and/or notify the users of the security threat.

In further specific embodiments of the system, the logic of the software program is further configured to detect a change to the software program, and, in response to detecting the change to the software program, generate an updated NFT and communicate the updated NFT to the distributed trust computing network. In response to the distributed trust computing network receiving the updated NFT, the decentralized nodes of the distributed trust computing network are configured to (i) reach a consensus on the updated NFT to verify the authenticity of the change to the software program, and (ii) create a second block of data within the distributed ledger that stores the verified updated NFT. In related embodiments the system further includes a computing platform including a memory and at least one processing device in communication with the memory. The memory stores a threat monitoring application that is executable by the at least one processing device and is configured to monitor the distributed trust computing network for an occurrence of a failure of the decentralized nodes to reach a consensus on an updated NFT, and, in response to determining the occurrence of the failure of the decentralized nodes to reach the consensus on the updated NFT, implement one or more appropriate actions to prevent proliferation of a security threat. In other related embodiments of the system, the logic is further configured to link the updated NFT to at least one chosen from group consisting of the device, a user of the device, an Internet Protocol (IP) address assigned to the device and a licensee of the software program, and wherein the second block of data within the distributed ledger stores data that identifies at least one chosen from the group consisting of the device, the user, the IP address and the licensee.

In still further specific embodiments, the system includes a computing platform including a memory and at least one processing device in communication with the memory. The memory stores a software command control application that is executable by the at least one processing device and is configured to grant a developer of the software program access to the distributed ledger to determine at least one chosen from the group consisting of (i) devices on which the software program is installed, (ii) users of the software program. In related embodiments of the system, the software command center is configured to grant licensees of the software program limited access to a portion of the distributed ledger to determine at least one chosen from the group consisting of (i) a portion of the devices on which the software program is installed, wherein the portion of the devices are controlled or authorized by the licensee, and (ii) a portion of the users of the software program, (i.e., the portion of the users that have been granted access to the software program by the licensee).

A computer-implemented method for software authenticity and traceability defines second embodiments of the invention. The computer-implemented method is executed by one or more processing devices. The computer-implemented method includes detecting, via logic within a software program, an installation of the software on a device and, in response to the detection of the installation of the software program on the device, generating, via the logic within the software program, a non-fungible token (NFT) and communicating the NFT to a distributed trust computing network. The distributed trust computing network including a plurality of decentralized nodes. Each decentralized node having a first memory and at least one first processor in communication with the memory. The first memory of the decentralized nodes is configured to store a distributed ledger comprising a plurality of blocks of data. The computer-implemented method further includes, in response to the distributed trust computing network receiving the NFT, verifying the authenticity of the software program by the decentralized nodes reaching a consensus on the NFT, and in response to verifying the authenticity of the software program, generating a first block of data within the distributed ledger that stores at least the verified NFT.

In specific embodiments the computer-implemented method further includes linking the NFT to at least one chosen from group consisting of the device, one or more users of the device, an Internet Protocol (IP) address assigned to the device and a licensee of the software program. In such embodiments of the computer-implemented method, the second block of data within the distributed ledger stores data that identifies at least one chosen from the group consisting of the device, the one or more users, the IP address, and the licensee.

In further specific embodiments, the computer-implemented method includes monitoring the software program for an occurrence of a security threat and, in response to detecting a security threat, accessing the distributed ledger to determine at least one of (i) devices on which the software program is installed, and (ii) users of the software program. In response to determining one of (i) the devices on which the software program is installed, or (ii) the users of the software program, perform at least one of (α) an action at the devices to prevent the security threat from affecting the devices, and (b) notify the users of the security threat.

In other specific embodiments, the computer-implemented method includes detecting, via the logic in the software program, a change to the software program, and, in response to detecting the change the software program, generating, via the logic in the software program, an updated NFT and communicating the updated NFT to the distributed trust computing network. In response to the distributed trust computing network receiving the NFT, verifying the authenticity of the change to the software program by the decentralized nodes reaching a consensus on the updated NFT, and, in response, generating a second block of data within the distributed ledger that stores at least the verified updated NFT. In related embodiments, the computer-implemented method includes monitoring the distributed trust computing network for an occurrence of a failure of the decentralized nodes to reach a consensus on the updated NFT and, in response to determining the occurrence of the failure of the decentralized nodes to reach the consensus on the updated NFT, implementing one or more appropriate actions to prevent proliferation of a security threat.

A computer program product including a non-transitory computer-readable medium defines third embodiments of the invention. The non-transitory computer-readable medium includes a first set of codes for causing a computer to detect an installation of the software on a device and a second set of codes for causing a computer to, in response to the detection of the installation of the software program on the device, generate a non-fungible token (NFT). The computer-readable medium additionally includes a third set of codes for causing a computer to communicate the NFT to a distributed trust computing network. The distributed trust computing network includes a plurality of decentralized nodes, each decentralized node having a first memory and at least one first processor in communication with the memory. The first memory of the decentralized nodes is configured to store a distributed ledger having a plurality of blocks of data. The computer-readable medium additionally includes a fourth set of codes for causing a computer to, in response to the distributed trust computing network receiving the NFT, verify the authenticity of the software program by the decentralized nodes reaching a consensus on the NFT, and a fifth set of codes for causing a computer to, in response to verifying the authenticity of the software program, generate a first block of data within the distributed ledger that stores at least the verified NFT.

In specific embodiments of the computer program product, the second set of codes is further configured to link the NFT to at least one chosen from group consisting of the device, one or more users of the device, an Internet Protocol (IP) address assigned to the device and a licensee of the software program and the fifth set of codes is further configured to generate the first block of data within the distributed ledger that stores data that identifies at least one chosen from the group consisting of the device, the one or more users, the IP address and the licensee. In related embodiments of the computer program product, the computer-readable medium includes (α) a sixth set of codes for causing a computer to monitor the software program for an occurrence of a security threat, (b) a seventh set of codes for causing a computer to, in response to detecting a security threat, access the distributed ledger to determine at least one of (i) devices on which the software program is installed, and (ii) users of the software program, and (c) an eighth set of codes for causing a computer to, in response to determining one of (i) the devices on which the software program is installed, or (ii) the users of the software program, perform at least one of (1) an action at the devices to prevent the security threat from affecting the devices, and (2) notify the users of the security threat.

In further specific embodiments of the computer program product, the computer-readable medium includes a sixth set of codes for causing a computer to detect a change to the software program and a seventh set of codes for causing a computer to, in response to detecting the change to the software program, generate an updated NFT. Additionally, the computer-readable medium includes an eighth set of codes for causing a computer to communicate the updated NFT to the distributed trust computing network and a ninth set of codes for causing a computer to in response to the distributed trust computing network receiving the NFT, verifying the authenticity of the patch or revision to the software program by the decentralized nodes reaching a consensus on the updated NFT. Moreover, the computer-readable medium includes a tenth set of codes for causing a computer to, in response to verifying the authenticity of the patch or the revision to the software program, generate a second block of data within the distributed ledger that stores at least the verified updated NFT. In related embodiments of the computer program product, the computer-readable medium includes an eleventh set of codes for causing a computer to monitor the distributed trust computing network for an occurrence of a failure of the decentralized nodes to reach a consensus on the updated NFT, and a twelfth set of codes for causing a computer to, in response to determining the occurrence of the failure of the decentralized nodes to reach the consensus on the updated NFT, implement one or more appropriate actions to prevent proliferation of a security threat.

Thus, according to embodiments of the invention, which will be discussed in greater detail below, the present invention addresses needs and/or achieves other advantages by providing the ability to validate the authenticity of software and provide traceability on a device and/or user-level. In this regard, software is configured with logic that detects installation and, in some embodiments, change (i.e., upgrade, patches or the like) and, in response generates a non-fungible token (NFT) that is subsequently verified via a distributed trust computing network. In specific embodiments, the NFT is linked to one or more of the device, the user(s), IP address(es), the licensee, such that a distributed ledger storing the linked NFTs can be accessed to readily determine which devices the software is installed on and the users of the software.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block of a distributed trust computing network, in accordance with embodiments of the present invention;

FIG. 2 is a schematic/block diagram of a non-fungible token (NFT)-based system for software authenticity and traceability, in accordance with embodiments of the present invention;

FIG. 3 is a schematic/block diagram of a non-fungible token (NFT)-based system for determining a security threat posed by software and, in response, readily identifying the devices and/or users of the software, in accordance with alternate embodiments of the present invention;

FIG. 4 is a block diagram of a software program configured for generating NFTs in response to installation of or changes to software, in accordance with embodiments of the present invention;

FIG. 5 is a block/schematic diagram for a non-fungible token (NFT)-based system for determining that a NFT presented within a distributed trust network cannot be validated and, in response, taking appropriate actions to prevent the security threat posed, in accordance with embodiments of the present invention;

FIG. 6 is a block/schematic diagram for a system controlling access to NFTs and related information stored on a distributed ledger of a distributed trust computing network, in accordance with embodiments of the present invention; and

FIG. 7 is flow diagram of a method for validating the authenticity of software and providing traceability of use at the device and/or user-level, in accordance with alternate embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform may include a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide the ability to validate the authenticity of software and trace/track software on a device and/or user-level. In this regard, software is configured by the developer with logic/code that detects installation and, in some embodiments, changes to the software (i.e., upgrade, patches or the like) and, in response, generates a non-fungible token (NFT) that is subsequently verified via a distributed trust computing network. Such verification at the distributed trust computing network authenticates the software and/or software updates.

In specific embodiments, the NFT is linked to one or more of the device, the user(s), IP address(es), the licensee, such that a distributed ledger storing the linked NFTs can be accessed to readily determine which devices the software is installed on and the users of the software. The ability to readily determine which specific devices software is installed on and/or the specific users of the software becomes paramount in the event that the software is compromised or otherwise poses a security threat. As such, in specific embodiments of the invention, a threat monitoring system is used in conjunction with the NFT-based platform, such that in response to identifying a security threat, the distributed ledger is accessed to identify devices and/or users of the software and appropriate actions are taken at the device-level and/or the user-level.

In further embodiments of the invention, when unauthorized changes occur to the software, the distributed trust computing network will fail to validate the updated NFT that was generated as a result of the change. In this instance, the invention provides for taking appropriate actions, such as preventing the use of the software on the device, isolating the device from network communication and the like.

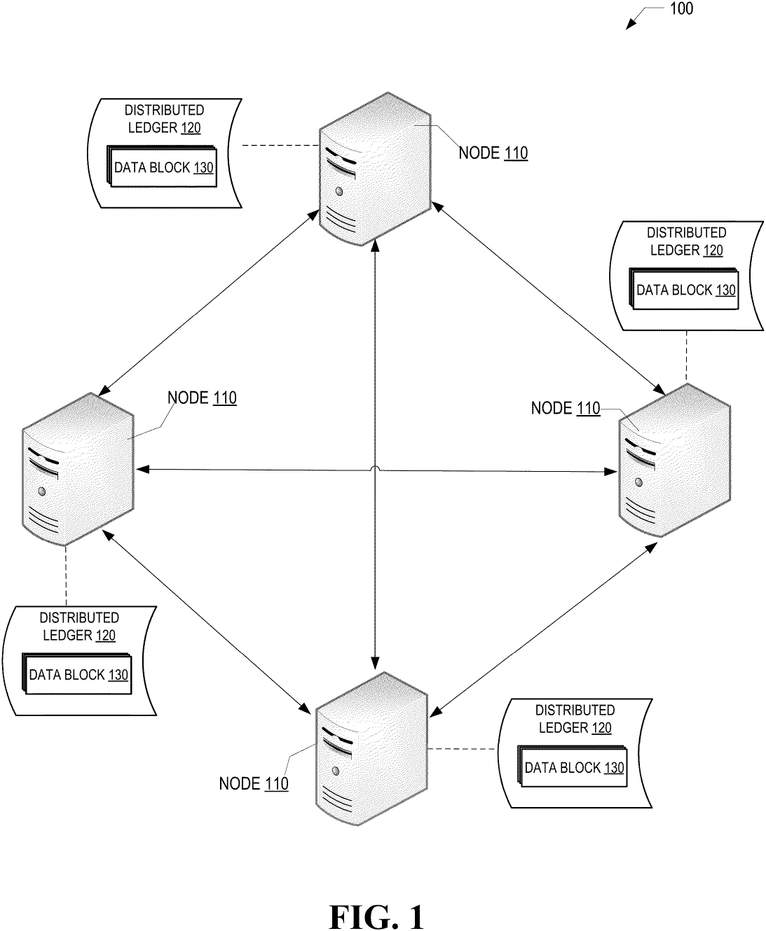

Referring to FIG. 1 a schematic diagram of an exemplary distributed trust computing network 100 is depicted, in accordance with embodiments of the present invention. The distributed trust computing network 100, in other instances referred to a blockchain network, is a distributed database that maintains, e.g., a list of data records, or the like. In specific embodiments of the invention the data records may include non-fungible tokens (NFTs) that serve to verify the authenticity of the software that generated the token and data linked to the NFT, such as, the device on which the software is installed, the user of the software, the IP address of the device on which the device is installed, the company/licensee of the software and the like. The linked data provides traceability at the device an/or user-level. The security of the data maintained within the trust network is enhanced by the distributed nature of the network. The distributed trust computing network 100 typically includes several decentralized nodes 110, which may be one or more systems, machines, computers, databases, data stores or the like operably connected with one another. In some instances, each of the nodes 110 or multiple nodes 110 are maintained by different entities. A distributed trust computing network 100 typically works without a central repository or single administrator.

A distributed trust computing network 100 provides numerous advantages over traditional storage networks/databases. A large number of the decentralized nodes 110 of a trust network may reach a consensus regarding the validity of resources or data maintained with a block of the distributed trust computing network, in the context of the present invention the validity of software installations and/or updates based on generation and presentation of a NFT.

The distributed trust computing network 100 typically has two primary types of records. The first type is the record type, which consists of the actual data stored in a data block 130 within a distributed register/ledger 120. The second type is the block type, which are records that confirm when and in what sequence certain events became recorded as part of the distributed trust computing network. Records, such as a code change file segment records, and the events associated therewith are created by participants using the distributed trust computing network in its normal course of business, for example, when code change file segment is determined, a data block(s) 130 is created by users known as “miners” who use specialized software/equipment to create data blocks 130. Holders of a data block 130 of the distributed trust computing network 100 agree to store the data block 130 within the distributed trust computing network 100 and the related data blocks 130 are passed around to various nodes 110 of the distributed trust computing network 100. A “valid” data block 130 or related event is one that can be validated based on a set of rules that are defined by the particular system implementing the distributed trust computing network 100. For example, in the case of software installation/update, a valid data block is one that verifies the authenticity of the software being installed and/or the updates/revisions to the software and, in some instances, the validity of the linked data (i.e., the device, user, IP address, licensee or the like).

A distributed trust computing network 100 is typically decentralized - meaning that a distributed register/ledger 120 (i.e., a decentralized register/ledger) is maintained on multiple nodes 110 of the distributed trust computing network 100. In this regard, one node 110 in the distributed trust computing network 100 may have a complete or partial copy of the distributed register/ ledger 120 or set of records and/or blocks 130 on the distributed trust computing network 100. Transactions/events (i.e., newly presented NFTS) are initiated at a node 110 of a distributed trust computing network 100 and communicated to the various other nodes 110 of the distributed trust computing network 100 for validation purposes. Any of the nodes 110 can validate the content of a data block 130 or an associated event, add the data block 130 and/or the contents of the data block 130 to its copy of the distributed register/ledger 120, and/or broadcast the detail/data of the data block 130, its associated validation (in the form of a data block 130) and/or other data to other nodes 130.

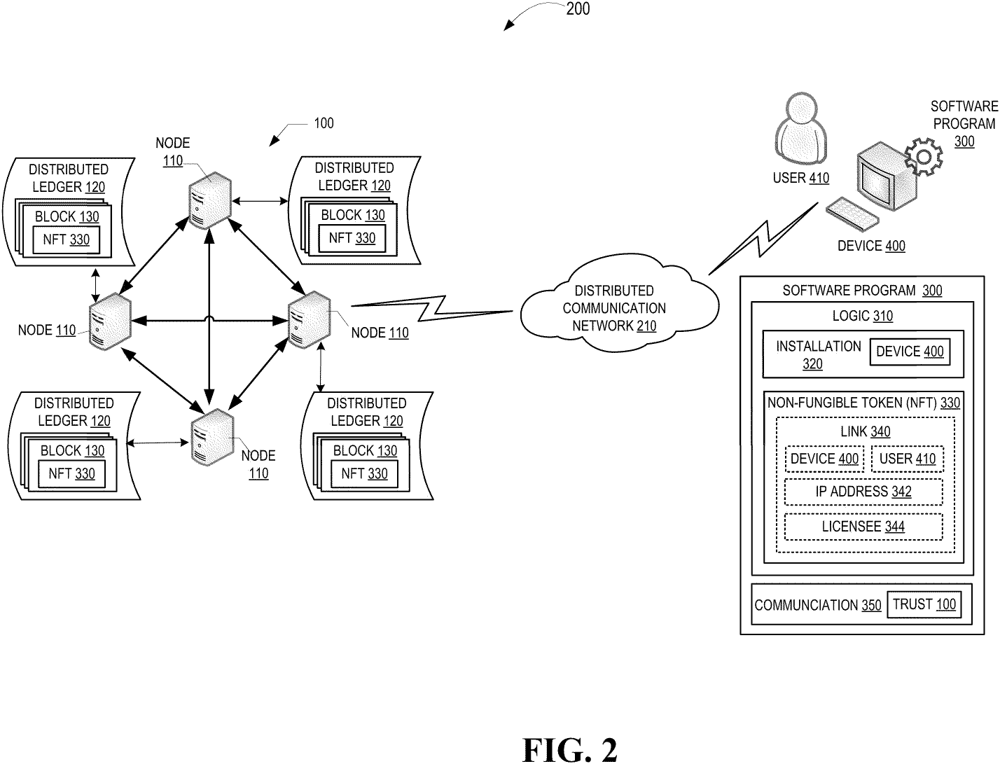

Referring to FIG. 2, a schematic/block diagram is presented of an NFT-based system 100 for verifying the authenticity of a software being installed and, in some embodiments, providing traceability for the software on the device and/or user-level. The system 100 is implemented within a distributed communication network 210 that may include the Internet, one or more intranets, one or more cellular networks, one or more short-range wireless networks or the like.

The system includes a distributed trust computing network 100 including a plurality of decentralized nodes 110. Each decentralized node 110 having a memory (not shown in FIG. 2) and at least one processing device (not shown in FIG. 1). The first memory of the decentralized nodes 110 is configured to store a distributed ledger 120 that includes a plurality of data blocks 130.

The system 100 additionally includes a software program 300 that includes logic 310 that is configured to detect installation 320 of the software program 300 on a device 400. In response to detecting the installation 320 of the software program 300 on the device 400, the logic 310 is further configured to generate a Non-Fungible Token (NFT) 330. An NFT, as used herein, is a unit of data used as a unique digital identifier stored on a digital ledger that certifies ownership and authenticity of a resource. As known by those of ordinary skill in the art, NFTs cannot be copied, substituted, or subdivided. In specific embodiments of the system 200, the NFT 330 is linked to one or more of (i) the device 400, (ii) the user 410 of the software program 400, (iii) the IP address(es) 342 of the device 400 and/or (iv) the licensee 344 of the software program 300. Linking of the NFT 330 to (i) the device 400, (ii) the user 410 of the software program 400, (iii) the IP address(es) 342 of the device 400 and/or (iv) the licensee 344 provides traceability of the software program 300 on a device/user/licensee-level.

Once the NFT 330 has been generated, communication 350 of the NFT 330 to the distribute trust communication network 100 occurs. In response to the distributed trust computing network 100 receiving the NFT 330, the decentralized nodes 110 of the trust computing network 100 are configured to reach a consensus on the NFT 330 to verify the authenticity of the software program 300 and create a first data block 130 within the distributed ledger 120 that stores the verified NFT 330 and, in some embodiments of the system 100, information that identifies the linked (i) device 400, (ii) user 410, (iii) IP address(es) 342 and/or (iv) licensee 344.

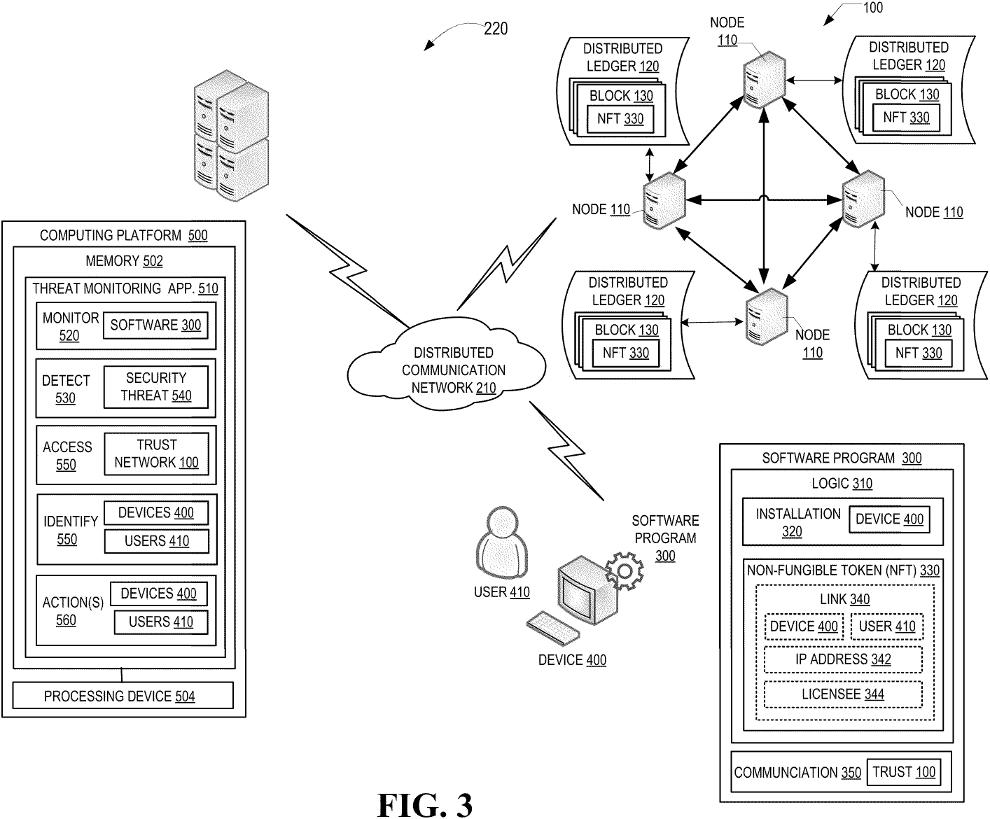

Referring to FIG. 3, a schematic/block diagram is presented of an alternate NFT-based system 220 for determining a security threat posed by software and, in response, readily identifying the devices and/or users of the software, in accordance with embodiments of the present invention. The system 220 includes both the distributed trust computing network 100 and software program 300 discussed in relation to FIG. 2. The system additionally includes a computing platform 500 that is in network communication with the distributed trust computing network 100 via distributed communication network 210. Computing platform 500 comprises one or more computing devices/apparatus, such as application servers or the like configured to execute software programs, including instructions, engines, algorithms, modules, routines, applications, tools, and the like. Computing platform 500 includes second memory 502, which may comprise volatile and non-volatile memory, EPROM, EEPROM, flash cards, or any memory common to computer platforms. Moreover, second memory 502 may comprise cloud storage, such as provided by a cloud storage service and/or a cloud connection service.

Further, computing platform 500 also includes second processing device(s) 504, which may be an application-specific integrated circuit (“ASIC”), or other chipset, logic circuit, or other data processing device. Second processing device 504 may execute an application programming interface (“API”) (not shown in FIG. 3) that interfaces with any resident programs, such as threat monitoring application 510 and algorithms, sub-engines/routines associated therewith or the like stored in the second memory 502 of computing platform 500.

Second processing device(s) 504 may include various processing subsystems (not shown in FIG. 3) embodied in hardware, firmware, software, and combinations thereof, that enable the functionality of computing platform 500 and the operability of computing platform 500 on a distributed communication network 210. For example, processing subsystems allow for initiating and maintaining communications and exchanging data with other networked devices. For the disclosed aspects, processing subsystems of second processing device(s) 504 may include any subsystem used in conjunction with threat monitoring application 510 and related engines, routines, algorithms, sub-algorithms, modules, sub-modules thereof.

Computing platform 500 additionally includes a communications module (not shown in FIG. 3) embodied in hardware, firmware, software, and combinations thereof, that enables electronic communications between computing platform 500 and other networks and/or networked devices, such as, distributed trust computing network 100 and the like. Thus, the communication module may include the requisite hardware, firmware, software and/or combinations thereof for establishing and maintaining a network communication connection with one or more systems, platforms, networks, or the like.

Second memory 502 of computing platform 500 stores threat monitoring application 510 that is configured to monitor 520 the totality of use of software program 300 and, in response to detection 530 of a security threat 540, access 550 the distributed trust computing network 100 to identify one or more of (i) the devices 400 on which the software program 300 is installed and/or (ii) the users 410 of the software program. As previously discussed, the NFTs 330 are stored within data blocks 130 of the distributed ledger 120 and may be linked to the devices 400 and/or users 410, such that the data block 130 containing an NFT 330 also stores information that identifies the linked device 400 and/or user 410. Thus, an authorized user of the distributed trust computing network 100, such as a software developer or the like, can access the network 100 to identify devices 400 and/or users 410.

In response to identifying the devices 400 and/or the users 410, threat monitoring application 510 is further configured to perform an action 560 to prevent the security threat 540 from propagating on the devices 400 or otherwise affecting the users 410.

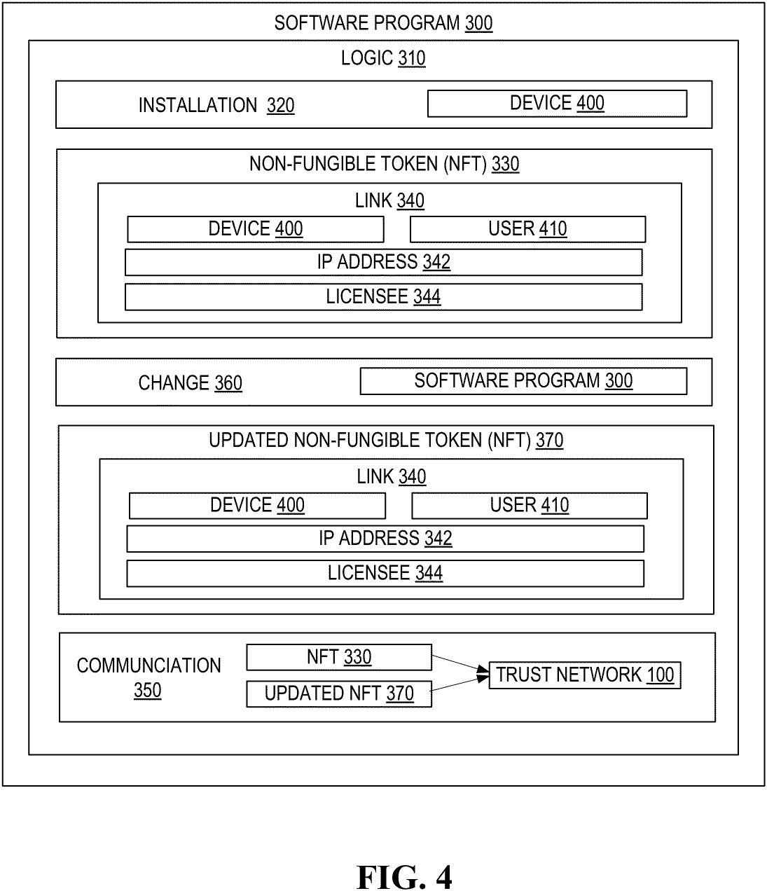

Referring to FIG. 4, a block diagram is presented of software program 300 that is configured to generate NFTs 330 in response to installation 320 of the software program 300 and updated NFTs 370 in response to a change 360 to the software program 300, in accordance with embodiments of the present invention. As previously discussed in relation to FIG. 2, software program 300 includes logic 310 that is configured to detect installation 320 of the software program 300 on a device 400. In response to detecting the installation 320 of the software program 300 on the device 400, the logic 310 is further configured to generate a Non-Fungible Token (NFT) 330.

In specific embodiments of the system 200, the NFT 330 is linked to one or more of (i) the device 400, (ii) the user 410 of the software program 400, (iii) the IP address(es) 342 of the device 400 and/or (iv) the licensee 344 of the software program 300. Linking of the NFT 330 to (i) the device 400, (ii) the user 410 of the software program 400, (iii) the IP address(es) 342 of the device 400 and/or (iv) the licensee 344 provides traceability of the software program 300 on a device/user/licensee-level. Linking of the NFT to (i) the device 400, (ii) the user 410 of the software program 400, (iii) the IP address(es) 342 of the device 400 and/or (iv) the licensee 344 of the software program 300 may include accessing an Operating System (OS) kernel to identify the device (e.g., MAC address, or one or more other unique signatures of the device, such as component serial numbers or the like), the user, IP address, licensee or the like.

In additional embodiments, the software program 300 may be configured to detect new users 410 of the software program 300 (i.e., users 410 other than the user 410 that was using the software program at the time of installation). In such embodiments of the invention, detection of a new/additional user 410 may prompt generation of an NFT token that is subsequently communicated to the trust computing network 100 for verification of the authenticity of the user and storage within a data block 130 of the distributed ledger 120.

In additional specific embodiments of the invention, logic 310 is configured to detect a change 360 to the software program 300. The change may be an authorized change (e.g., revision, update, patch, or the like) or an unauthorized change (e.g., nefarious action or the like). In response to detecting the change 360 to the software program 300, the logic 310 is further configured to generate an updated Non-Fungible Token (NFT) 370. In specific embodiments of the invention, the updated NFT 370 is linked to one or more of (i) the device 400, (ii) the user 410 of the software program 400, (iii) the IP address(es) 342 of the device 400 and/or (iv) the licensee 344 of the software program 300.

Once the NFT 330 and/or updated NFT 370 have been generated, communication 350 of the NFT 330 and/or updated NFT 370 to the distribute trust communication network 100 occurs. As previously discussed in relation to FIG. 2, in response to the distributed trust computing network 100 receiving the NFT 330 or updated NFT 370, the decentralized nodes 110 of the trust computing network 100 are configured to reach a consensus on the NFT 330 or updated NFT 370 to verify the authenticity of the software program 300 and/or the changes to the software program 300 and create a first data block 130 within the distributed ledger 120 that stores the verified NFT 330 or verified updated NFT 370 and, in some embodiments of the system 100, information that identifies the linked (i) device 400, (ii) user 410, (iii) IP address(es) 342 and/or (iv) licensee 344.

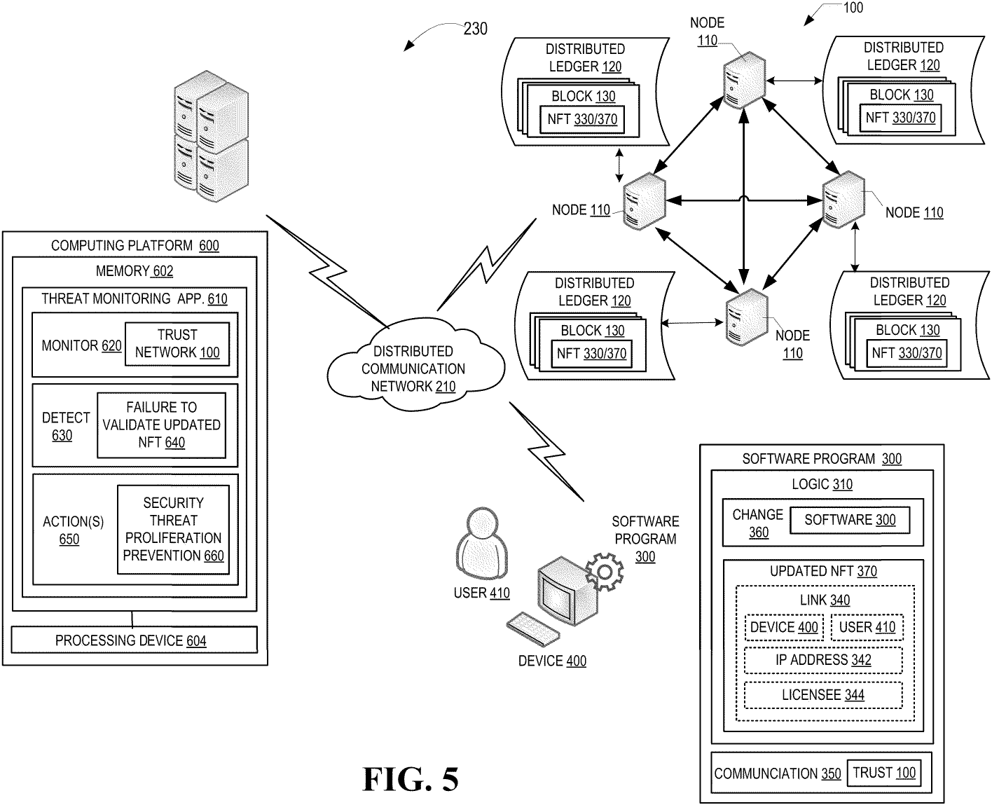

Referring to FIG. 5, a schematic/block diagram is presented of an alternate NFT-based system 230 for monitoring the distributed trust computing network for an occurrence of a failure to verify an NFT and, in response, performing an action to mitigate a security threat, in accordance with embodiments of the present invention. The system 230 includes both the distributed trust computing network 100 and software program 300 discussed in relation to FIG. 2. The system additionally includes a computing platform 600 that is in network communication with the distributed trust computing network 100 via distributed communication network 210. Similar to the computing platform 500 discussed in relation to FIG. 3, computing platform 600 comprises one or more computing devices/apparatus, such as application servers or the like configured to execute software programs, including instructions, engines, algorithms, modules, routines, applications, tools, and the like. Computing platform 600 includes second memory 602, which may comprise volatile and non-volatile memory, EPROM, EEPROM, cloud storage or any memory common to computer platforms.

Further, computing platform 600 also includes second processing device(s) 604, which may be an application-specific integrated circuit (“ASIC”), or other chipset, logic circuit, or other data processing device. Second processing device 604 may execute an application programming interface (“API”) (not shown in FIG. 5) that interfaces with any resident programs, such as threat monitoring application 610 and algorithms, sub-engines/routines associated therewith or the like stored in the second memory 602 of computing platform 600. Moreover, second processing device(s) 604 may include various processing subsystems (not shown in FIG. 5) embodied in hardware, firmware, software, and combinations thereof, that enable the functionality of computing platform 600 and the operability of computing platform 600 on a distributed communication network 210. For example, processing subsystems allow for initiating and maintaining communications and exchanging data with other networked devices. For the disclosed aspects, processing subsystems of second processing device(s) 604 may include any subsystem used in conjunction with threat monitoring application 610 and related engines, routines, algorithms, sub-algorithms, modules, sub-modules thereof.

Computing platform 600 additionally includes a communications module (not shown in FIG. 5) embodied in hardware, firmware, software, and combinations thereof, that enables electronic communications between computing platform 600 and other networks and/or networked devices, such as, distributed trust computing network 100 and the like. Thus, the communication module may include the requisite hardware, firmware, software and/or combinations thereof for establishing and maintaining a network communication connection with one or more systems, platforms, networks, or the like.

Second memory 602 of computing platform 600 stores threat monitoring application 610 that is configured to monitor 620 the distributed trust computing network 100 and detect 630 an occurrence of a failure to validate an updated NFT 370. Monitoring 620 may include receiving notification from the distributed trust computing network 100 of an occurrence of a failure 640 to validate an updated NFT 370. As previously discussed, an updated NFT 370 is generated in response to a change 360 in the software program 300. These changes 360 may be authorized changes (e.g., updates, revisions, patches, and the like) or unauthorized changes (e.g., someone tampering with the software intentionally or inadvertently). In the event that the changes 360 are unauthorized the nodes 110 of the distributed trust computing network 100 will fail to validate the updated NFT 370 (i.e., the change can not be verified/authenticated).

In response to detection 630 of the occurrence of a failure 640 to validate an updated NFT 370, threat monitoring application 610 is further configured to perform one or more actions 650 to mitigate/prevent 660 the proliferation of the security threat that is posed by the unauthorized change in the software program 300. Such actions, may include but are not limited to, deactivating the software program 300 on the device 400, isolating the device 400 from the distributed communication network 210, notifying the user(s) 410 of the software program 300 and the like.

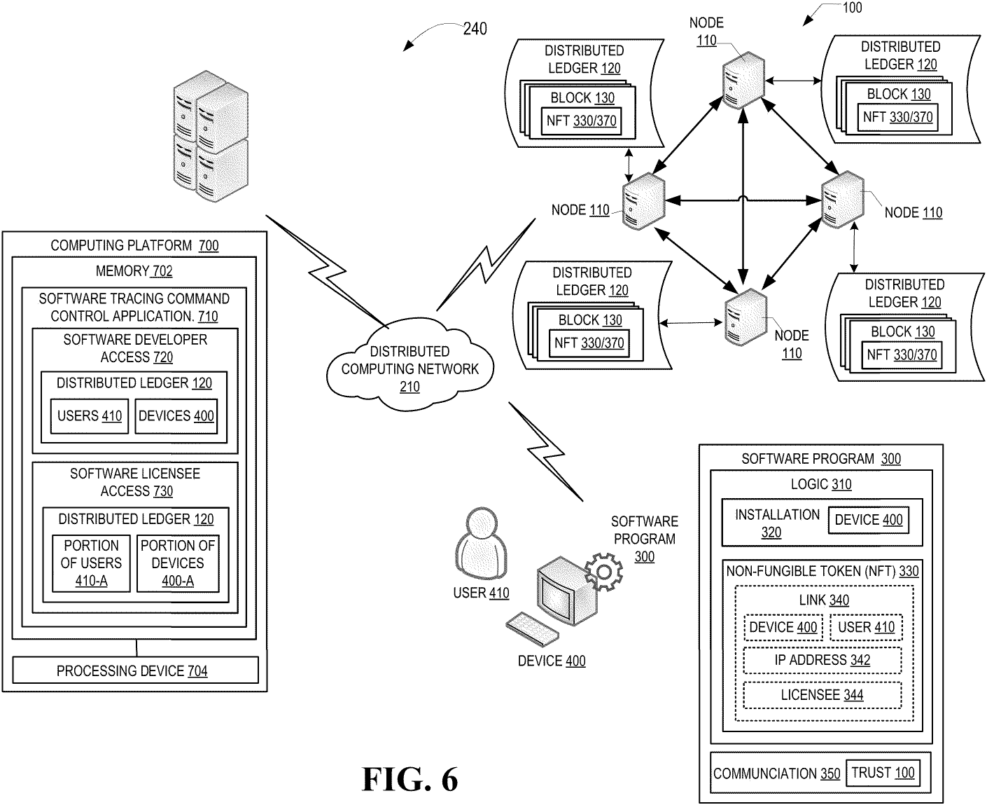

Referring to FIG. 6, a schematic/block diagram is presented of an alternate NFT-based system 240 for providing users access to software traceability information stored within a distributed trust computing network, in accordance with embodiments of the present invention. The system 240 includes both the distributed trust computing network 100 and software program 300 discussed in relation to FIG. 2. The system additionally includes a computing platform 700 that is in network communication with the distributed trust computing network 100 via distributed communication network 210. Similar to the computing platform 500 discussed in relation to FIG. 3, computing platform 700 comprises one or more computing devices/apparatus, such as application servers or the like configured to execute software programs, including instructions, engines, algorithms, modules, routines, applications, tools, and the like. Computing platform 700 includes second memory 702, which may comprise volatile and non-volatile memory, EPROM, EEPROM, cloud storage or any memory common to computer platforms.

Further, computing platform 700 also includes second processing device(s) 704, which may be an application-specific integrated circuit (“ASIC”), or other chipset, logic circuit, or other data processing device. Second processing device 704 may execute an application programming interface (“API”) (not shown in FIG. 6) that interfaces with any resident programs, such as software tracing command control application 710 and algorithms, sub-engines/routines associated therewith or the like stored in the second memory 702 of computing platform 700. Moreover, second processing device(s) 704 may include various processing subsystems (not shown in FIG. 6) embodied in hardware, firmware, software, and combinations thereof, that enable the functionality of computing platform 700 and the operability of computing platform 700 on a distributed communication network 210. For example, processing subsystems allow for initiating and maintaining communications and exchanging data with other networked devices. For the disclosed aspects, processing subsystems of second processing device(s) 704 may include any subsystem used in conjunction with software tracing command control application 710 and related engines, routines, algorithms, sub-algorithms, modules, sub-modules thereof.

Computing platform 700 additionally includes a communications module (not shown in FIG. 6) embodied in hardware, firmware, software, and combinations thereof, that enables electronic communications between computing platform 700 and other networks and/or networked devices, such as, distributed trust computing network 100 and the like. Thus, the communication module may include the requisite hardware, firmware, software and/or combinations thereof for establishing and maintaining a network communication connection with one or more systems, platforms, networks, or the like.

Second memory 702 of computing platform 700 stores software tracing command control application 710 that is configured to control user access to the information stored on distributed ledger 120 and specifically control access to the information linked to the NFTs 330, 370. Specifically, software tracing command control application is configured to grant a developer of the software program access 720 to the distributed ledger 120 to determine all devices 400 on which the software program 300 is currently installed or has previously been installed on and/or any users 400 that have used the software program.

Moreover, software tracing command control application 710 that is configured to grant licensees partial access to the information linked to the NFTs 330. Specifically, the software tracing command control application 710 is configured to grant licensees access 730 to the distributed ledger 120 to determine only the devices 410-A in control of the licensee and/or only the users 400-A associated with the licensee.

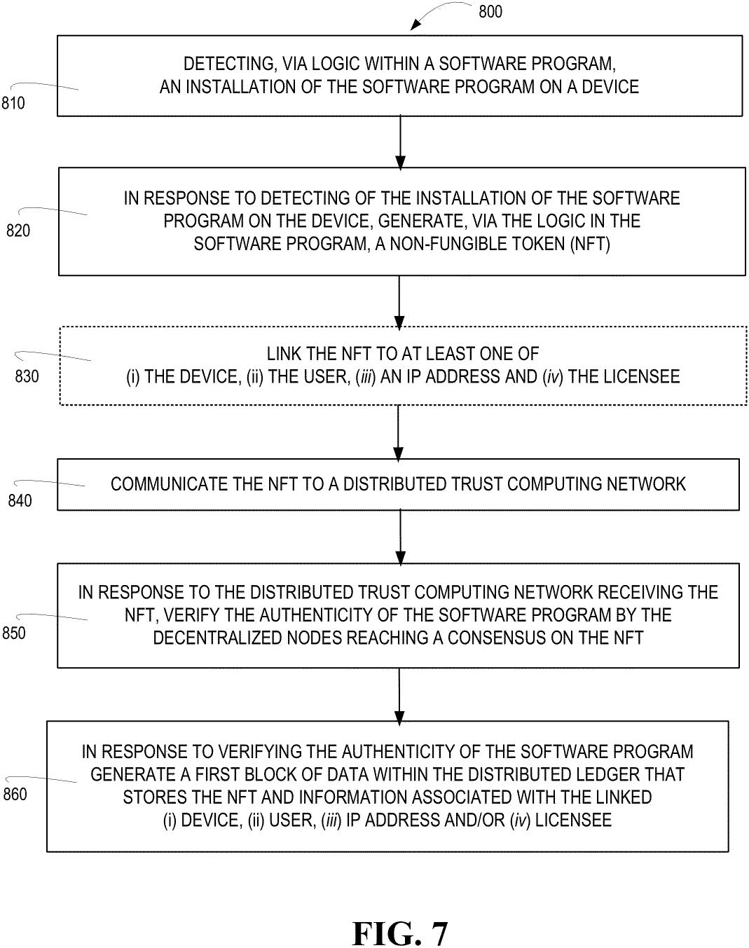

Referring to FIG. 7, a flow diagram is depicted of a method 800 for verifying authenticity of software and providing software traceability at a device and/or user-level through use of NFTs, in accordance with embodiments of the present invention. At Event 810, logic/code within a software program detects that the software program is being installed on a device. In response to detecting the installation of the software program on a device, at Event 820, a non-fungible token (NFT) is generated.

At Event 830, the NFT is linked to one or more of (i) the device on which the software program is being installed, (ii) the user of the device, (iii) IP address(es) of the device, and/or (iv) the licensee. In specific embodiments of the invention linking and generating the NFT may occur in unison, such that, the NFT itself comprises encrypted code or the like, which upon decryption identifies the linked (i) device, (ii) user(s), (iii) IP address(es), and/or (iv) licensee.

At Event 840, the NFT is communicated to a distributed trust computing network, which, upon receipt, at Event 850, verifies the authenticity of the software program by the centralized nodes of the trust network reaching a consensus on the NFT. In response to verifying the authenticity of the software program, at Event 850, a first data block is generated within the distributed ledger of the distributed trust computing network that stores the NFT and information associated with the linked (i) device, (ii) user, (iii) IP address and/or (iv) licensee. In this regard, the distributed ledger provides software traceability on a device-level and/or a user-level should the need exist to identify the devices on which the software program is installed and/or the users of the software program.

Thus, as described in detail above, present embodiments of the invention include systems, methods, computer program products and/or the like for validating the authenticity of software and providing software traceability on a device and/or user-level. In this regard, software is configured with logic that detects installation and, in some embodiments, change (i.e., upgrade, patches or the like) and, in response generates a non-fungible token (NFT) that is subsequently verified via a distributed trust computing network. In specific embodiments, the NFT is linked to one or more of the device, the user(s), IP address(es), licensee, such that a distributed ledger storing the linked NFTs can be accessed to readily determine which devices the software is installed on and the users of the software. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for software authenticity and traceability, the system comprising;
a distributed trust computing network comprising a plurality of decentralized nodes, each decentralized node having a first memory and at least one first processing device in communication with the memory, wherein the first memory of the decentralized nodes is configured to store a distributed ledger comprising a plurality of blocks of data; and
a software program with logic, wherein the logic is configured to:
detect an installation of the software program on a device,
in response to the detection of the installation of the software program on the device, generate a non-fungible token (NFT),
communicate the NFT to the distributed trust computing network,
wherein in response to the distributed trust computing network receiving the NFT, the decentralized nodes of the distributed trust computing network are configured to (i) reach a consensus on the NFT to verify an authenticity of the software program, and (ii) create a first block of data within the distributed ledger that stores the verified NFT.

2. The system of claim 1, wherein the logic is further configured to link the NFT to at least one chosen from group consisting of the device, one or more users of the device, an Internet Protocol (IP) address assigned to the device and a licensee of the software program, and wherein the first block of data within the distributed ledger stores data that identifies at least one chosen from the group consisting of the device, the one or more users, the IP address and the licensee.

3. The system of claim 2, wherein the logic of the software program is further configured to link the NFT to at least one chosen from group consisting of the device, a user of the device, an Internet Protocol (IP) address assigned to the device and a licensee of the software program by accessing an Operating System (OS) kernel to identify at least one chosen from the group comprising one or more unique signatures of the device, one or more unique signatures of the one or more users, the IP address or the licensee.

4. The system of claim 2, further comprising:
a computing platform including a second memory and at least one second processing device in communication with the second memory, wherein the second memory stores a threat monitoring application that is executable by the at least one second processing device and is configured to:
monitor the software program for an occurrence of a security threat,
in response to detecting a security threat, access the distributed ledger to determine devices on which the software program is installed, and
in response to determining the devices on which the software program is installed, perform an action at the devices to prevent the security threat from affecting the devices.

5. The system of claim 4, wherein the threat monitoring application is further configured to:
in response to detecting a security threat; access the distributed ledger to users of the software program,
in response to determining the users of the software program, notify the users of the security threat.

6. The system of claim 1, wherein the logic of the software program is further configured to:
detect a change to the software program,
in response to detecting the change to the software program, generate an updated NFT,
communicate the updated NFT to the distributed trust computing network,
wherein in response to the distributed trust computing network receiving the updated NFT, the decentralized nodes of the distributed trust computing network are configured to (i) reach a consensus on the updated NFT to verify the authenticity of the change to the software program, and (ii) create a second block of data within the distributed ledger that stores the verified updated NFT.

7. The system of claim 6, further comprising a computing platform including a second memory and at least one second processing device in communication with the second memory, wherein the second memory stores a threat monitoring application that is executable by the at least one second processing device and is configured to:
monitor the distributed trust computing network for an occurrence of a failure of the decentralized nodes to reach a consensus on an updated NFT, and
in response to determining the occurrence of the failure of the decentralized nodes to reach the consensus on the updated NFT, implement one or more appropriate actions to prevent proliferation of a security threat.

8. The system of claim 6, wherein the logic is further configured to link the updated NFT to at least one chosen from group consisting of the device, a user of the device, an Internet Protocol (IP) address assigned to the device and a licensee of the software program, and wherein the second block of data within the distributed ledger stores data that identifies at least one chosen from the group consisting of the device, the user, the IP address and the licensee.

9. The system of claim 2, further comprising:
a computing platform including a second memory and at least one second processing device in communication with the second memory, wherein the second memory stores a software command control application that is executable by the at least one second processing device and is configured to:
grant a developer of the software program access to the distributed ledger to determine at least one chosen from the group consisting of (i) devices on which the software program is installed, (ii) users of the software program.

10. The system of claim 9, wherein the software command control application is further configured to:
grant licensees of the software program limited access to a portion of the distributed ledger to determine at least one chosen from the group consisting of (i) a portion of the devices on which the software program is installed, wherein the portion of the devices are controlled or authorized by the licensee and (ii) a portion of the users of the software program, wherein the portion of the users have been granted access to the software program by the licensee.

11. A computer-implemented method for software authenticity and traceability, the computer-implemented method is executed by one or more processing devices and comprising;
detecting, via logic within a software program, an installation of the software on a device;
in response to the detection of the installation of the software program on the device, generating, via the logic within the software program, a non-fungible token (NFT);
communicating the NFT to a distributed trust computing network comprising a plurality of decentralized nodes, each decentralized node having a first memory and at least one first processor in communication with the memory, wherein the first memory of the decentralized nodes is configured to store a distributed ledger comprising a plurality of blocks of data;
in response to the distributed trust computing network receiving the NFT, verifying the authenticity of the software program by the decentralized nodes reaching a consensus on the NFT; and
in response to verifying the authenticity of the software program, generating a first block of data within the distributed ledger that stores at least the verified NFT.

12. The computer-implemented method of claim 11, further comprising:
linking the NFT to at least one chosen from group consisting of the device, one or more users of the device, an Internet Protocol (IP) address assigned to the device and a licensee of the software program, and
wherein the second block of data within the distributed ledger stores data that identifies at least one chosen from the group consisting of the device, the one or more users, the IP address, and the licensee.

13. The computer-implemented method of claim 12, further comprising:
monitoring the software program for an occurrence of a security threat;
in response to detecting a security threat, accessing the distributed ledger to determine at least one of (i) devices on which the software program is installed, and (ii) users of the software program; and
in response to determining one of (i) the devices on which the software program is installed, or (ii) the users of the software program, perform at least one of (a) an action at the devices to prevent the security threat from affecting the devices, and (b) notify the users of the security threat.

14. The computer-implemented method of claim 11, further comprising:
detecting, via the logic in the software program, a change to the software program;
in response to detecting the change the software program, generating, via the logic in the software program, an updated NFT;
communicating the updated NFT to the distributed trust computing network;
in response to the distributed trust computing network receiving the NFT, verifying the authenticity of the change to the software program by the decentralized nodes reaching a consensus on the updated NFT; and
in response to verifying the authenticity of the change to the software program, generating a second block of data within the distributed ledger that stores at least the verified updated NFT.

15. The computer-implemented method of claim 14, further comprising:
monitoring the distributed trust computing network for an occurrence of a failure of the decentralized nodes to reach a consensus on the updated NFT; and
in response to determining the occurrence of the failure of the decentralized nodes to reach the consensus on the updated NFT, implementing one or more appropriate actions to prevent proliferation of a security threat.

16. A computer program product including a non-transitory computer-readable medium, the non-transitory computer-readable medium comprising:
a first set of codes for causing a computer to detect an installation of a software program on a device;
a second set of codes for causing a computer to, in response to the detection of the installation of the software program on the device, generate a non-fungible token (NFT);
a third set of codes for causing a computer to communicate the NFT to a distributed trust computing network comprising a plurality of decentralized nodes, each decentralized node having a first memory and at least one first processor in communication with the memory, wherein the first memory of the decentralized nodes is configured to store a distributed ledger comprising a plurality of blocks of data;
a fourth set of codes for causing a computer to, in response to the distributed trust computing network receiving the NFT, verify the authenticity of the software program by the decentralized nodes reaching a consensus on the NFT; and
a fifth set of codes for causing a computer to, in response to verifying the authenticity of the software program, generate a first block of data within the distributed ledger that stores at least the verified NFT.

17. The computer program product of claim 16, wherein the second set of codes is further configured to link the NFT to at least one chosen from group consisting of the device, one or more users of the device, an Internet Protocol (IP) address assigned to the device and a licensee of the software program, and
wherein the fifth set of codes is further configured to generate the first block of data within the distributed ledger that stores data that identifies at least one chosen from the group consisting of the device, the one or more users, the IP address and the licensee.

18. The computer program product of claim 17, wherein the computer-readable medium further comprising:
a sixth set of codes for causing a computer to monitor the software program for an occurrence of a security threat;
a seventh set of codes for causing a computer to, in response to detecting a security threat, access the distributed ledger to determine at least one of (i) devices on which the software program is installed, and (ii) users of the software program; and
an eighth set of codes for causing a computer to, in response to determining one of (i) the devices on which the software program is installed, or (ii) the users of the software program, perform at least one of (a) an action at the devices to prevent the security threat from affecting the devices, and (b) notify the users of the security threat.

19. The computer program product of claim 16, wherein the computer-readable medium further comprising:
a sixth set of codes for causing a computer to detect a change to the software program;
a seventh set of codes for causing a computer to, in response to detecting the change to the software program, generate an updated NFT;
an eighth set of codes for causing a computer to communicate the updated NFT to the distributed trust computing network;
a ninth set of codes for causing a computer to in response to the distributed trust computing network receiving the NFT, verifying the authenticity of the change to the software program by the decentralized nodes reaching a consensus on the updated NFT; and
a tenth set of codes for causing a computer to, in response to verifying the authenticity of the change to the software program, generate a second block of data within the distributed ledger that stores at least the verified updated NFT.

20. The computer program product of claim 19, wherein the computer-readable medium further comprises:
an eleventh set of codes for causing a computer to monitor the distributed trust computing network for an occurrence of a failure of the decentralized nodes to reach a consensus on the updated NFT; and
a twelfth set of codes for causing a computer to, in response to determining the occurrence of the failure of the decentralized nodes to reach the consensus on the updated NFT, implement one or more appropriate actions to prevent proliferation of a security threat.
